(19) United States
(12) Patent Application Publication
(10) Pub. No.: US 2007/0233796 A1
(43) Pub. Date: Oct. 4, 2007

(54) Automatic verification of messenger contact data

(75) Inventor: Michael Oschmann, Nurnberg (DE)

Correspondence Address: LERNER GREENBERG STEMER LLP, P O BOX 2480, HOLLYWOOD, FL, 33022-2480, US

(73) Assignee: Muller Marken GmbH & Co. Betriebs-KG

(21) Appl. No.: 11/732,798

(22) Filed: Apr. 4, 2007

(30) Foreign Application Priority Data
Apr. 4, 2006 (EP) 06 007 112.3

(51) Int. Cl. G06F 15/16; H04L 9/32

(52) U.S. Cl. 709/206; 726/28

(57) ABSTRACT

The invention specifies a method, an apparatus and a computer program product for automatically verifying messenger contact data. In this context, a computer unit (2) receives input messenger data from a user via a data link (5) and automatically, as a subscriber in an instant messaging system (6) associated with the messenger contact data, uses the received messenger contact data to send to the user a message containing a piece of confirmation information. For verification purposes, a user input is registered in line with the confirmation information, and the messenger contact data are then verified.

The invention relates to a method for automatic verification of messenger contact data and to an appropriately set-up computer system. The invention also relates to a computer program product which, when executed on a computer system, allows automatic verification of messenger contact data.

As a significant Internet service, a wealth of information and messages are today exchanged by e-mail between local computers having an Internet connection on a daily basis throughout the world. Like the sending of real letters, the e-mail service is a service which allows a sender to communicate with a receiver asynchronously. However, it is increasingly possible to use an instant messenger or instant messaging system to communicate with other subscribers in real time via a network and particularly via the Internet. In this case, the messages to be transmitted within an instant messaging system are sent directly to the receiver, who can respond to them directly. It is also possible to interchange files in this way.

Contact lists, which are also called buddy lists, are used by the instant messaging systems to allow a subscriber to learn the online status of the other subscribers shown in the contact list. In this case, the status which the other subscribers included in the contact list have is indicated to the subscriber as soon as he uses the instant messaging system. By way of example, such a status may be “online”, “absent”, “offline” etc.

Instant messaging systems are provided by various operators. The fact that some protocols are proprietary means that the various instant messaging systems are sometimes incompatible with one another. The instant messaging systems are therefore respectively available only to the subscribers signed on with the relevant operator, who can communicate with the other signed on subscribers within the closed system.

Nevertheless, real-time communication within an instant messaging system has since developed into a frequently used alternative to asynchronous e-mail. As in the case of e-mail addresses, which allow an addressee or a receiver to be identified, what are known as messenger contact data are interchanged which allow a subscriber to be reached in a corresponding instant messaging system. It is therefore to be expected that in addition to the telephone numbers of both the landline network and the mobile radio network and the e-mail address, in future the messenger contact data, which essentially contain the address within a specific messaging system, could also become the customary contact data for a person.

It is therefore necessary to check indicated messenger contact data for their authenticity and for their association with the respective user, that is to say to verify them. Such verification is necessary, by way of example, in order to be able to establish trustworthiness necessary for forming a transaction when the messenger contact data of an Internet user are known. Such verification also makes sense when messenger contact data associated with specific users are published in a public reference work, for example.

It is therefore an object of the invention to specify a method and an apparatus which allow verification of messenger contact data.

The invention achieves the former object with regard to the method by means of a method for automatically verifying messenger contact data, where a computer unit receives input messenger contact data from a user via a data link, the computer unit automatically, as a subscriber in an instant messaging system associated with the messenger contact data, uses the received messenger contact data to send to the user a message containing a piece of confirmation information, a user input is registered in line with the confirmation information, and the messenger contact data are then verified.

In this case, the invention is based, in a first step, on the insight that the instant messaging systems are closed systems in which only the signed-on subscribers respectively communicate with one another or are notified of the respective online status of other, selected subscribers in the same system. The different instant messaging systems are respectively produced by dedicated software from the appropriate operator and are therefore incompatible with one another in some cases.

In a second step, the invention is based on the consideration that contact data can be verified by directly contacting a person using the contact data indicated by him. This is because in this case the association and the existence of the indicated contact data can be checked by using a piece of confirmation information to ask for an appropriate reaction from the person contacted using his contact data. If the expected reaction occurs, there is the assurance that the indicated contact data are associated with the relevant person and are existent.

In a third step, the invention is finally based on the consideration that a person cannot be contacted in automated fashion per se using his indicated messenger contact data, since the respective instant messaging system is available only to signed-on subscribers. Automatic sending of the confirmation information in a similar manner to automatically created e-mails is therefore not possible. However, this problem can be solved surprisingly by virtue of a computer unit automatically appearing as a subscriber in an instant messaging system. To this end, the computer unit is signed on in an instant messaging system as a subscriber using its own messenger contact data and can as such communicate and interchange data and messages with other subscribers within the instant messaging system. To communicate within the instant messaging system, the signed-on computer unit technically merely needs to be rendered capable of automatically sending messages to other subscribers. This can be achieved by appropriate hardware and/or software.

To verify input messenger contact data from a user, said data are routed to the relevant computer unit. Through the power of an appropriate hardware block or appropriate piece of software, the computer unit accepts the received messenger contact data, ascertains the associated instant messaging system from them and uses the received messenger contact data to send a message containing a piece of confirmation information to the user within the associated instant messaging system, as a signed-on subscriber. A virtual subscriber of this kind, particularly in an instant messaging system, is also called a “robot”, or “bot” for short.

Only if the confirmation information is also supplied to the user waiting for a confirmation or a message, for example, using the indicated messenger contact data is said user able to use the confirmation information to react accordingly. Hence, when a user input is registered in line with the confirmation information, the messenger contact data can then be verified.

The invention does not require that a user input be registered in line with the confirmation information or that the verification be performed by the computer unit which appears as a virtual subscriber in an instant messaging system. Equally, it is also possible for the registration and verification to be performed by another computer unit, which is connected to the computer unit appearing as a subscriber.

The invention affords the advantage that messenger contact data can be verified automatically. In particular, this method can also be carried out in real time provided that the user inputting the messenger contact data is in an online status. The messenger contact data which are input on the user's home PC, for example, are routed via a network, such as the Internet, to the computer unit which sends the confirmation information to the user via the network within the relevant instant messaging system. The user input made in line with the confirmation information is in turn registered via the network, whereupon the messenger contact data are verified.

The verification option provided by the invention for messenger contact data can be used particularly by all online services which wish to check the trustworthiness of the respective user before their provided services are used. By way of example, the online services may be online mail order business, an online auction exchange or a service provider of any kind, which provides its services to third parties particularly over the Internet. In particular, the automated verification of messenger contact data can also be used to check them for their truth before they are entered in a public reference work, such as a telephone book or the like.

To reduce the handling time for the verification of messenger contact data, provision may be made for a plurality of “bots” to be used which communicate as virtual subscribers for the purpose of verification in the instant messaging system(s). In particular, various “bots” may be used for various online services. Typically, a respective “bot” is used for every online service.

In one advantageous refinement, the received messenger contact data are stored at least temporarily in a database. Storage in a database affords the advantage that a plurality of messenger contact data items can be managed. In particular, it is possible to mark as yet unverified messenger contact data as such, which in the case of temporary storage may be deleted after a certain time or at the end of an unsuccessful session. Particularly for the purpose of creating a public reference work, it makes sense in this context to mark the verified messenger contact data in the database separately. This allows verified messenger contact data to be distinguished from unverified messenger contact data, which ensures that only verified messenger contact data are published in the reference work.

In order to attain the highest possible degree of contactability, a user of a reference work will want to publish as many of his messenger contact data items as possible in his entry. So that, during online input of his messenger contact data, he is sufficiently well informed about which of his messenger contact data are adopted for publication, it is advantageous if the user is notified that verification has taken place. Such notification naturally also makes sense for a user of an online service, since in this way he learns about successful conclusion of the action performed. When an online mail order company is used, the user in this way learns that his order has been accepted and that the order is now being handled by the online mail order company, for example.

To manage a plurality of messenger contact data items or to handle a large number of verification operations which are to be performed, a temporary identification is expediently produced for each user. This identification can be used to associate a registered user input with the user or with the relevant messenger contact data in line with the transmitted confirmation information. The identification is performed particularly whenever messenger contact data are received.

To make it easier to identify registered user inputs, it is also advantageous if the confirmation information is produced on a user-specific basis. This means that as an alternative or in addition to a temporary identification produced for each user, a registered user input can be clearly associated with the respective messenger contact data in line with the user-specific confirmation information. This is possible because each user receives a piece of confirmation information distinguishing him from another user such that the relevant user input distinguishes him from other users.

If messenger contact data from a user need to be verified for different instant messaging systems then it is expedient if the confirmation information is produced on the basis of the respective instant messaging system. This allows a user input which has been made in line with the confirmation information to be associated directly with the messaging contact data from a specific instant messaging system.

As confirmation information, the user can be sent a specific piece of information with the simultaneous request to input this information and return it to the sender, for example. In this case, the information can be returned by e-mail, within the instant messaging system or by web form. In particular, an address can be indicated as the sender, said address controlling the computer unit which acts as the virtual subscriber in the instant messaging system or being associated with an online service which is currently frequented by the user. As a specific piece of information, it is possible to use a password, a PIN number or another code, for example. The user can be requested to input this specific piece of information through direct opening of an input panel, for example, which is controlled by the computer unit or by a computer from the online service.

Advantageously, the confirmation information sent is a link referring to a confirmation URL, where the verification takes place when the domain to which the confirmation URL refers is called. In this case, the term URL stands for “Uniform Resource Location” and expresses an address which can be clearly identified on the Internet. The confirmation information is used to ask the user to click on the link sent to him as confirmation. Clicking on this link opens a connection between the user and the stored address (domain) in the Internet network, which is easy to register. Sending a confirmation URL affords the advantage, in particular, that the user allows his messenger contact data to be verified by a single action, namely clicking on the link which has been sent. In this respect, such a practice is not susceptible to error and consequently has a high level of reliability.

In another variant, a called online service uses an online connection to ask the user to input the messenger contact data. By way of example, this is done when the user uses an online connection to access an online service's server in order to request a service directly, such as to place an online order, in particular. Before the desired action is completed, in this case the user is asked by the online service, via the online connection, to input the messenger contact data. This means that the online service will want to check the credibility of its future contractual partner. When the messenger contact data have been input, they are transmitted to the computer unit, which then, as a virtual subscriber within the associated instant messaging system, sends to the user a message containing a piece of confirmation information. If the online service is a provider of a public reference work, for example, then the request for the messenger contact data can also be made several times in succession, in order to be able to verify all messenger contact data of different instant messaging systems provided for entering the user and hence to be able to provide them for entry.

To perform the verification, the computation unit can use the data link to communicate with a computer from the online service, for example, which receives the messenger contact data and forwards them to the computation unit. For this, it is possible to use an existing computer from an online service, for example, such as a WEB server, in order to effect the information handling between the user and the online service. For the registration, a downstream computer unit is provided which is made ready for a virtual subscriber in a number of instant messaging systems by means of appropriate messenger contact data. In this regard, this computer unit has the aforementioned “bot” implemented on it. To perform the verification, the “bot” receives the messenger contact data transmitted to it by the online service's computer and uses these messenger contact data to communicate, as a subscriber within the associated instant messaging system, with the respective user. In turn, a user input can be registered, in line with the transmitted confirmation information, by the online service's computer by taking a sent confirmation URL directly to an address managed by the WEB server, for example. Since it makes use of available resources, this solution provides a significant cost advantage.

If the computer unit of such a computer system, which comprises the computer unit appearing as the virtual subscriber and a computer from an online service, is implemented as a whole with the online service provider then the verification takes place exclusively with the online service as such. However, since such a practice has associated costs regarding implementation, servicing and operation of the computer unit, one suitable advantageous variant is for the computer unit on which the “bot” is installed to be set up separately with a provider of the automatic verification. The costs for installation, maintenance and operation of the computer unit on which the “bot” is installed are then the responsibility of the provider of the automatic verification for messenger contact data.

Depending on the design of the computer system, the data transmission benefits from being in the form of a direct connecting line or, when there is physical separation between the computer unit and the online service's computer, from being produced by means of a public network. In the latter case, an Internet, in particular, is suitable as a public network, with the communication via the Internet advantageously taking place in encrypted form.

The invention achieves the object relating to an apparatus by means of a computer system having a data input and a network connection which is set up to receive messenger contact data from a user via the data input, to use the network connection for automatically, as a subscriber in an instant messaging system associated with the messenger contact data, using the received messenger contact data to send to the user a message containing a piece of confirmation information, to register a user input in line with the confirmation information and then to verify the messenger contact data.

Further advantageous embodiments can be found in the subclaims respectively relating to a computer system. In this context, the advantages cited for the method can each be transferred mutatis mutandis to the computer system of appropriate design.

In particular, it is advantageous if the computer system comprises a computer unit and a computer from an online service with the network connection which are connected to one another via a data link, where the computer is set up to receive the messenger contact data and to forward them to the computer unit. Such a computer system affords the option of physical separation between the computer unit acting as a virtual subscriber in a number of instant messaging systems and the online service's computer handling the communication with the user. This allows optimum use of available resources, and particularly allows the fundamental part of the automatic verification of messenger contact data to be carried out externally.

The invention also achieves the stated object by means of a computer program product which, when executed on a computer system with a data input and a network connection, allows said computer system to carry out the method for automatic verification of messenger contact data described above.

The computer program product allows a computer system to receive messenger contact data from a user via the data input, to use the network connection for automatically, as a subscriber in an instant messaging system associated with the messenger contact data, using the received messenger contact data to send to the user a message containing a piece of confirmation information, and to register a user input in line with the confirmation information and then to verify the messenger contact data.

The advantages cited for a method can be transferred to the computer program product mutatis mutandis. In particular, the computer program product contains the repeatedly mentioned “bot”, which allows the computer unit to use received messenger contact data to automatically appear or to communicate as a subscriber using known messenger contact data in an instant messaging system.

Exemplary embodiments of the invention are explained in more detail with reference to a drawing, in which:

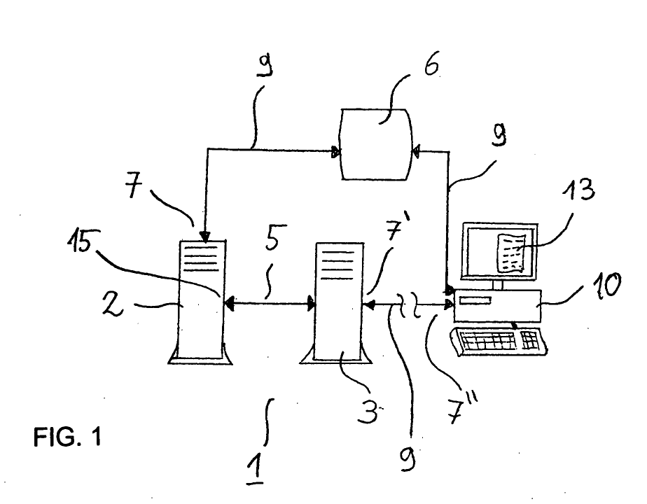

FIG. 1 schematically shows a computer system for carrying out automatic verification of messenger contact data, and

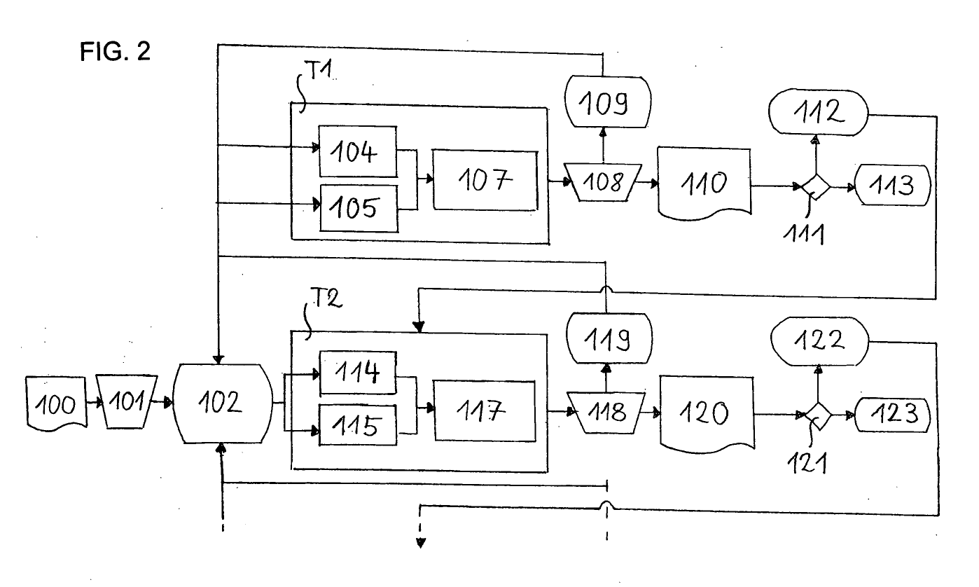

FIG. 2 shows a flowchart for carrying out the method of automatic verification of messenger contact data.

FIG. 1 shows the basic design of a computer system 1 which is suitable for carrying out automatic verification of messenger contact data. To this end, the computer system 1 comprises a computer unit 2 and a computer 3 for an online service. In this case, the online service's computer 3 is a WEB server which is connected to the computer unit 2 by means of a data link 5, which can either be in the form of a direct connection or can be implemented by means of a public network, such as the Internet, in particular. The computer unit 2 has what is known as a “bot” installed on it in the form of a computer program product which allows the computer unit 2 to communicate as a virtual subscriber within an instant messaging system 6. For this, the computer unit 2 is registered under its own messenger contact data in a number of instant messaging systems.

The online service's computer 3 is used to handle online ordering business. For this, the online service's computer 3 provides a relevant user with the available products, including the associated prices, as information. Similarly, the computer 3 provides a user online with an appropriate order form or input mask which is accordingly suitable for ordering.

Both the online service's computer 3 and the computer unit 2, which communicates in virtual fashion in the instant messaging system 6, have a network connection 7, 7′. The network connection 7, 7′ allows both units to communicate via a public network such as the Internet 9.

A user frequenting the online service's ordering service uses his PC 10 which is set up at home, and which likewise has a network connection 7″, to make contact via the Internet 9 with the online service's computer 3 first of all. The user wishes to use the online service's ordering service and to order a particular product. Following selection of the relevant product, the user is asked by the online service's computer 3, which is in the form of a WEB server, using a sign-on form 13, to input his messenger contact data. To complete the order process successfully, the user will enter his relevant messenger contact data into the sign-on form 13 appearing on the screen on his home PC 10. When the input has been made, these messenger contact data are available to the online service's computer 3.

To verify the messenger contact data, which is a prerequisite for starting the ordering process, the online service's computer 3 uses the data link 5 to route the messenger contact data received to the computer unit 2. There, the received messenger contact data are stored, temporarily at first, in a database. The computer unit 2 then uses the Internet 9 to communicate as a virtual subscriber in the instant messaging system 6 associated with the messenger contact data. Using the received messenger contact data, the computer unit 2 uses the instant messaging system 6 to send to the user, again via the Internet 9, a confirmation URL as a piece of confirmation information with the simultaneous request to click on the link referring to the confirmation URL in order to successfully complete his online order. This can be done using the words “to confirm your entered messenger contact data, please click on the link below”, for example.

The confirmation URL sent refers directly to a domain managed by the online service's computer 3. By clicking on the relevant link, the user 3 accesses the corresponding address, managed by the computer 3, using his home PC 10 via the Internet 9 and the network connection 7′. This access is registered by the computer 3, whereupon the input messenger contact data are verified and the ordering process is successfully completed. Successful verification or the successful completion of the ordering process is used to inform the user on his home PC 10 via the Internet 9 as appropriate. To identify the confirmation URL, the computer unit 2 produces, in each case for the messenger contact data received, an identification which it communicates together with the allocated confirmation URL to the online service's computer 3. Following a successful session, the temporarily stored messenger contact data are deleted on the computer unit 2.

Alternatively, the computer unit (2) manages the domain to which the confirmation URL sent refers. In this case, the access to the address managed by the computer unit (2) is also registered by the computer unit (2), whereupon the messenger contact data are verified. The verification is then communicated to the online service's computer (2) via an appropriate data channel, for example the data link 5. When there are various online services to be dealt with, the computer unit (2) manages a prescribed domain, for example, and assigns the respective online services specific subdomains to which the specific confirmation URLs refer. The subdomains can therefore be used to identify and manage various online services. This refinement is particularly suitable for a provider of the automatic verification. Said provider then has the installed computer unit (2), which manages the various subdomains for different online services.

FIG. 2 shows an appropriate flowchart to illustrate the automatic verification of messenger contact data. The method shown is automatic verification of messenger contact data which a user inputs online for the purpose of entry in a public reference work for the provider publishing the reference work.

The verification method starts with method step 100, in which, as FIG. 1 shows, the user of a home PC 10 wishing to have his messenger contact data published in a public reference work is asked by means of a sign-on form 13 to input his messenger contact data. In line with the request, the user enters his messenger contact data into the sign-on form 13 in method step 101. In method step 102, the input messenger contact data are stored temporarily in a database and marked as “unverified”. The database stores the messenger contact data respectively associated with an instant messaging system so that they can each be identified individually. The storage of the messenger contact data is implemented on the computer unit 2 as shown in FIG. 1, said computer unit 2 being able to communicate using an installed “bot” as a virtual subscriber in a number of instant messaging systems.

Following identification of the instant messaging system associated with a set of messenger contact data, which instant messaging system is referred to as Messenger T1 by way of example in FIG. 2, method steps 104 and 105 are used to produce a temporary identification, associated with the set of messenger contact data, on the computer unit 2 shown in FIG. 1 to generate a confirmation URL, which is dependent on the user and on the instant messaging system, associated with this identification. The confirmation URL which can thus be associated both with the user and with the set of messenger contact data is automatically sent to the user's messenger client in method step 107. When the confirmation URL is sent, the user is requested to click on the confirmation URL in order to verify his input messenger contact data.

In method step 108, the user clicks on the confirmation URL sent to him to confirm that firstly he can actually be contacted using the input messenger contact data and that secondly the messenger contact data actually exist. The confirmation URL call initiated by clicking is registered in method step 109 and consequently the data record associated with the messenger contact data is marked as verified in the database.

Next, the confirmation of the verification is indicated to the user in method step 110 and at the same time an overview of the as yet unverified contact data is displayed in line with the temporarily stored further messenger contact data. By means of appropriate selection, the user can decide in method step 111 whether he now wishes to confirm as yet unconfirmed messenger contact data in line with method step 112 or whether he wishes to conclude the process in line with method step 113.

If the user wishes to confirm the further messenger contact data which are provided by him for entry into the public reference work, in line with method step 112, then the computer unit 2 shown in FIG. 1 continues to operate as a virtual subscriber in the associated instant messaging system of type Messenger T2 using the further messenger contact data.

For this, method steps 114 and 115, which correspond to method steps 104 and 105, are again used to produce a temporary identification associated with the user and to generate a user-specific confirmation URL associated with the instant messaging system. The rest of the method sequence shown in steps 117 to 123 is similar to the method steps 107 to 113 shown, but now the messenger contact data of Messenger T2 are verified.

The automatic verification shown for the input messenger contact data is carried out in similar fashion for each data record of messenger contact data which is associated with an instant messaging system, until either all input messenger contact data have been verified or the user the process in line with method step 113 or 123 following verification of a particular data record.

The messenger contact data which are finally marked as verified in the database are stored permanently and are published by the manager or provider of the public reference work so that they can be searched, in particular, for example via the Internet.

### LIST OF REFERENCE SYMBOLS

1 Computer system
2 Computer unit
3 Computer from the online service
5 Data link
6 Instant messaging system
7,7′,7″ Network connection
9 Internet
10 PC
13 Application form
15 Data input
100-123 Method steps
T1 Messenger T1
T2 Messenger T2

1-29. (canceled)

30. A method for automatically verifying messenger contact data, the method which comprises:
receiving in a computer unit input messenger contact data from a user via a data link;
upon receiving the messenger contact data, automatically sending, with the computer unit as a subscriber in an instant messaging system associated with the messenger contact data, via the received messenger contact data, to the user a message containing confirmation information;
registering a user input in line with the confirmation information; and
subsequently verifying the messenger contact data.

31. The method according to claim 30, which comprises storing the received messenger contact data at least temporarily in a database.

32. The method according to claim 31, which comprises marking the verified messenger contact data in the database.

33. The method according to claim 30, which comprises communicating the verification to the user.

34. The method according to claim 30, which comprises producing a temporary identification for each user.

35. The method according to claim 30, which comprises producing the confirmation information on a user-specific basis.

36. The method according to claim 30, which comprises producing the confirmation information on a basis of the instant messaging system.

37. The method according to claim 30, wherein the confirmation information is a link referring to a confirmation URL, and the verification takes place when a domain associated with the confirmation URL is called.

38. The method according to claim 30, which comprises using an online connection with a called online service to ask the user to input the messenger contact data.

39. The method according to claim 38, wherein the computer unit uses the data link to communicate with a computer in the online service which receives the messenger contact data and forwards the messenger contact data to the computer unit.

40. The method according to claim 38, wherein the computer unit communicates the confirmation information to a computer of the online service, and the computer of the online service verifies the messenger contact data upon registration of the user input in line with the confirmation information.

41. The method according to claim 38, which comprises establishing communication between the computer unit and a computer of the online service via a direct connecting line.

42. The method according to claim 38, which comprises establishing communication between the computer unit and a computer of the online service via a public network.

43. The method according to claim 38, which comprises establishing communication between the computer unit and a computer of the online service via an Internet connection.

44. The method according to claim 42, which comprises communicating in encrypted form.

45. A computer system, comprising:
a data input and a network connection configured to:
receive messenger contact data from a user via said data input;
utilize the network connection for automatically, as a subscriber in an instant messaging system associated with the messenger contact data and using the received messenger contact data, to send to the user a message containing a piece of confirmation information; and
register a user input in line with the confirmation information and then to verify the messenger contact data.

46. The computer system according to claim 45, further comprising a database for at least temporary storage of the received messenger contact data.

47. The computer system according to claim 46, configured to mark verified messenger contact data in the database as verified.

48. The computer system according to claim 45, configured to communicate the verification to the user through the network connection.

49. The computer system according to claim 45, configured to produce a temporary identification for each user.

50. The computer system according to claim 45, configured to produce the confirmation information on a user-specific basis.

51. The computer system according to claim 45, configured to produce the confirmation information on a basis of the instant messaging system.

52. The computer system according to claim 45, configured to set up to send a link referring to a confirmation URL as confirmation information and to verify the messenger contact data when a domain to which the confirmation URL refers is called.

53. The computer system according to claim 45, configured to use the network connection to ask the user to input the messenger contact data.

54. The computer system according to claim 45, which comprises a computer unit and an online service computer of an online service having the network connection, said computer unit and said online service computer being connected to one another via a data link, and said online service computer being set up to receive the messenger contact data and to forward the messenger contact data to the computer unit.

55. The computer system according to claim 54, wherein said computer unit is configured to communicate the confirmation information to said online service computer via said data link, and said online service computer is configured to register a user input in line with the confirmation information and to subsequently verify the messenger contact data.

56. The computer system according to claim 54, wherein said data link is a direct connecting line.

57. The computer system according to claim 54, wherein said data link is a public network connection.

58. The computer system according to claim 54, wherein said data link is an Internet connection.

59. The computer system according to claim 57, configured for encrypted communication via the public network connection.

60. A computer program product containing computer-executable instructions which, upon execution on a computer system with a data input and a network connection, enable the computer system to:
receive messenger contact data from a user via the data input;
utilize the network connection for automatically, as a subscriber in an instant messaging system associated with the messenger contact data, using the received messenger contact data to send to the user a message containing a piece of confirmation information; and
register a user input in line with the confirmation information and then to verify the messenger contact data.

61. A computer program product containing computer-executable instructions which, upon execution on a computer system with a data input and a network connection, enable the computer system to carry out the method according to claim 30.
